(19) United States
(12) Patent Application Publication
(10) Pub. No.: US 2023/0385494 A1
(43) Pub. Date: Nov. 30, 2023

(54) SYSTEM AND METHOD FOR SEMICONDUCTOR DEVICE COMPACT MODELING USING MULTIPLE SPECIALIZED ARTIFICIAL NEURAL NETWORKS FOR EACH SEMICONDUCTOR DEVICE OPERATION REGION

(71) Applicant: ALSEMY INC., Seoul (KR)

(72) Inventors: Chan Woo PARK, Seoul (KR); Jung Hwan PARK, Seoul (KR)

(21) Appl. No.: 18/320,809

(22) Filed: May 19, 2023

(30) Foreign Application Priority Data
May 24, 2022 (KR) 10-2022-0063608

(51) Int. Cl. G06F 30/3308; G06F 30/27

(52) U.S. Cl. CPC G06F 30/3308; G06F 30/27; G06F 2111/10

(57) ABSTRACT

A method of semiconductor device compact modeling using multiple specialized artificial neural networks for each semiconductor device operation region. The method can include applying channel width data, channel length data, or temperature data of the semiconductor device to a first mixture of experts (MoE) stage to generate a first MoE stage output including first information on characteristics of the semiconductor device according to presence or absence of a short channel effect of the semiconductor device. The method can also include applying the first MoE stage output and gate-source voltage data to a second MoE stage to generate a second MoE stage output including second information on the characteristics of the semiconductor device according to an on state or off state of the semiconductor device.

### BACKGROUND

### 1. Field of the Invention

The present invention relates to a method and system for semiconductor device compact modeling using multiple specialized artificial neural networks for each semiconductor device operation region, and more particularly, a method and system for semiconductor device compact modeling using multiple specialized artificial neural networks for each semiconductor device operation region capable of reducing a time required to generate a compact model.

### 2. Discussion of Related Art

Compact modeling bridges between semiconductor fabrication and circuit design in circuit simulation.

In compact modeling generation methods using a conventional neural network, there have been attempts to model different device operation regions by training one neural network, in which the operation regions are determined based on a gate-source voltage V_{GS}, a drain-source voltage VDS, and a body-source voltage VBS as well as all gate widths, gate lengths, and temperatures of semiconductor devices. That is, the compact modeling generation method using the conventional neural network has the disadvantage of requiring much training data and taking a long training time to train one neural network.

### RELATED ART DOCUMENT

### Patent Document

(Patent Document 1) Korea Patent Publication No. 10-2285516 (Jul. 29, 2021)

### SUMMARY OF THE INVENTION

The present invention is directed to providing a method and system for semiconductor device compact modeling using multiple specialized artificial neural networks for each semiconductor device operation region capable of requiring less training data and reducing a compact model generation time.

According to an aspect of the present invention, a method is provided semiconductor device compact modeling using multiple specialized artificial neural networks for each semiconductor device operation region, including: applying channel width data, channel length data, or temperature data of the semiconductor device to a first mixture of experts (MoE) stage to generate a first MoE stage output including first information on characteristics of the semiconductor device according to presence or absence of a short channel effect of the semiconductor device; applying the first MoE stage output and gate-source voltage data to a second MoE stage to generate a second MoE stage output including second information on the characteristics of the semiconductor device according to an on state or off state of the semiconductor device; and applying the second MoE stage output and drain-source voltage data to a third MoE stage to estimate a current of the semiconductor device according to a cutoff region, a linear region, or a saturation region of the semiconductor device.

The generating of the first MoE stage output may include: applying the channel width data, the channel length data, or the temperature data to a first expert network to generate a first expert network output including information on a first threshold voltage when the short channel effect exists in the semiconductor device; applying the channel width data, the channel length data, or the temperature data to a second expert network to generate a second expert network output including information on a second threshold voltage when the semiconductor device has a long channel; applying the channel width data, the channel length data, or the temperature data to a first gating network to generate a first weight for the first expert network output and a second weight for the second expert network output; weighting the first expert network output by the first weight and the second expert network output by the second weight to generate first weighted expert network outputs; and summing the first weighted expert network outputs to generate the first MoE stage output.

The generating of the second MoE stage output may include: applying the first MoE stage output and the gate-source voltage data to a third expert network to generate a third expert network output including information on a drain current when the semiconductor device is in the on state; applying the first MoE stage output and the gate-source voltage data to a fourth expert network to generate a fourth expert network output including the information on the drain current when the semiconductor device is in the off state; applying the first MoE stage output and the gate-source voltage data to a second gating network to generate a third weight for the third expert network output and a fourth weight for the fourth expert network output; weighting the third expert network output by the third weight and the fourth expert network output by the fourth weight to generate second weighted expert network outputs; and summing the second weighted expert network outputs to generate the second MoE stage output.

The generating of the third MoE stage output may include: applying the second MoE stage output and the drain-source voltage data to a fifth expert network to generate a fifth expert network output including information on a drain current when the semiconductor device is in the cutoff region; applying the second MoE stage output and the drain-source voltage data to a sixth expert network to generate a sixth expert network output including the information on the drain current when the semiconductor device is in the linear region; applying the second MoE stage output and the drain-source voltage data to a third gating network to generate a fifth weight for the fifth expert network output and a sixth weight for the sixth expert network output; weighting the fifth expert network output by the fifth weight and the sixth expert network output by the sixth weight to generate third weighted expert network outputs; and summing the third weighted expert network outputs to estimate the current.

According to another aspect of the present invention, there is provided a system for semiconductor device compact modeling using multiple artificial neural networks, including: a memory that stores instructions; and a processor that executes the instructions.

The instructions may be implemented to apply channel width data, channel length data, or temperature data of the semiconductor device to the first MoE stage to generate a first MoE stage output including first information on characteristics of the semiconductor device according to presence or absence of a short channel effect of the semiconductor device; apply the first MoE stage output and gate-source voltage data to a second MoE stage to generate a second MoE stage output including second information on the characteristics of the semiconductor device according to the on state or off state of the semiconductor device; and apply the second MoE stage output and drain-source voltage data to a third MoE stage to estimate a current of the semiconductor device according to a cutoff region, a linear region, or a saturation region of the semiconductor device.

The instructions to generate the first MoE stage output may be implemented to apply the channel width data, the channel length data, or the temperature data to a first expert network to generate a first expert network output including information on a first threshold voltage when the short channel effect exists in the semiconductor device, apply the channel width data, the channel length data, or the temperature data to a second expert network to generate a second expert network output including information on a second threshold voltage when the semiconductor device has a long channel, apply the channel width data, the channel length data, or the temperature data to a first gating network to generate a first weight for the first expert network output and a second weight for the second expert network output, weight the first expert network output by the first weight and the second expert network output by the second weight to generate first weighted expert network outputs, and sum the first weighted expert network outputs to generate the first MoE stage output.

The instructions to generate the second MoE stage output may be implemented to apply the first MoE stage output and the gate-source voltage data to a third expert network to generate a third expert network output including information on a drain current when the semiconductor device is in the on state, apply the first MoE stage output and the gate-source voltage data to a fourth expert network to generate a fourth expert network output including the information on the drain current when the semiconductor device is in the off state, apply the first MoE stage output and the gate-source voltage data to a second gating network to generate a third weight for the third expert network output and a fourth weight for the fourth expert network output, weight the third expert network output by the third weight and the fourth expert network output by the fourth weight to generate second weighted expert network outputs, and sum the second weighted expert network outputs to generate the second MoE stage output.

The instructions to generate the third MoE stage output may be implemented to apply the second MoE stage output and the drain-source voltage data to a fifth expert network to generate a fifth expert network output including information on a drain current when the semiconductor device is in the cutoff region, apply the second MoE stage output and the drain-source voltage data to a sixth expert network to generate a sixth expert network output including the information on the drain current when the semiconductor device is in the linear region, apply the second MoE stage output and the drain-source voltage data to a third gating network to generate a fifth weight for the fifth expert network output and a sixth weight for the sixth expert network output, and weight the fifth expert network output by the fifth weight and the sixth expert network output by the sixth weight to generate third weighted expert network outputs, and sum the third weighted expert network outputs to estimate the current.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a block diagram of a system for semiconductor device compact modeling using multiple specialized artificial neural networks for each semiconductor device operation region according to an embodiment of the present invention;

FIG. 2 is a block diagram for describing a method of semiconductor device compact modeling using multiple specialized artificial neural networks for each semiconductor device operation region according to an embodiment of the present invention;

FIGS. 3A and 3B are graphs of a gate width and a threshold voltage according to a gate length of a semiconductor device;

FIG. 4 is a graph of a drain current according to a gate-source voltage;

FIG. 5 is a graph of the drain current according to a drain-source voltage;

FIG. 6 is a flowchart for describing the method of semiconductor device compact modeling using multiple specialized artificial neural networks for each semiconductor device operation region according to the embodiment of the present invention;

FIG. 7 is a flowchart for describing an operation of generating a first mixture of experts (MoE) stage output of FIG. 6;

FIG. 8 is a flowchart for describing an operation of generating a second MoE stage output of FIG. 6;

FIG. 9 is a flowchart for describing an operation of generating a third MoE stage output of FIG. 6; and

FIGS. 10A and 10B are graphs of a conventional compact modeling method using one neural network and the method of semiconductor device compact modeling using multiple specialized artificial neural networks for each semiconductor device operation region of the present invention.

### DETAILED DESCRIPTION OF EXEMPLARY EMBODIMENTS

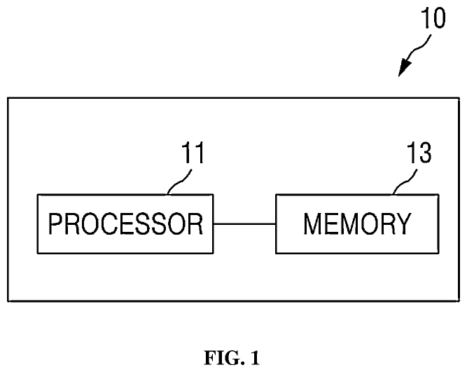

FIG. 1 is a block diagram of a system for semiconductor device compact modeling using multiple specialized artificial neural networks for each semiconductor device operation region according to an embodiment of the present invention.

Referring to FIG. 1, a system 10 for semiconductor device compact modeling using multiple specialized artificial neural networks for each semiconductor device operation region is a system capable of deriving a compact model using multiple specialized artificial neural networks for each semiconductor device operation region instead of a compact model using a conventional complex formula and applying the derived compact model to a simulator such as SPICE. The system 10 for semiconductor device compact modeling using multiple specialized artificial neural networks for each semiconductor device operation region may be an electronic device such as a server, a computer, a notebook, a tablet PC, or a personal PC.

The system 10 for semiconductor device compact modeling using multiple specialized artificial neural networks for each semiconductor device operation region includes a processor 11 and a memory 13. The processor 11 executes instructions with which the method of semiconductor device compact modeling is implemented. The memory 13 stores the instructions with which the method of semiconductor device compact modeling is implemented. Hereinafter, a specific method of semiconductor device compact modeling will be disclosed. The compact modeling is an operation of generating a compact model. The compact model is a simple mathematical description of a behavior of circuit elements constituting one semiconductor chip.

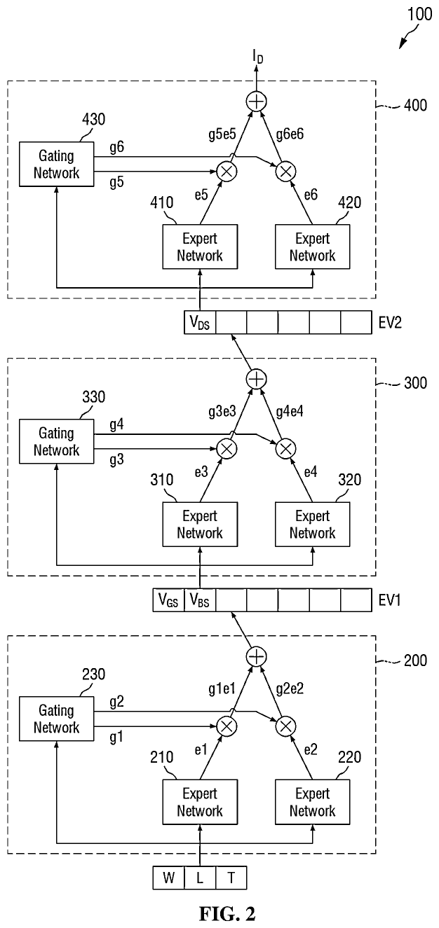

FIG. 2 is a block diagram for describing a method of semiconductor device compact modeling using multiple specialized artificial neural networks for each semiconductor device operation region according to an embodiment of the present invention.

Referring to FIGS. 1 and 2, a neural network 100 is implemented with instructions for generating a compact model stored in the memory 13. Hereinafter, in the neural network 100, instructions for generating a compact model stored in the memory 13 are executed by the processor 11.

The neural network 100 includes a plurality of mixture of expert (MoE) stages 200, 300, and 400. Unlike the related art, the present invention does not use one neural network, but uses the plurality of MoE stages 200, 300, and 400. The plurality of MoE stages 200, 300, and 400 are trained to model sub-characteristics of the semiconductor device. The sub-characteristics of the semiconductor device are a short channel effect of a transistor, a drain current I_{D} in an on state, the drain current I_{D} in an off state, the drain current I_{D} in a cutoff region, the drain current I_{D} in a linear region, the drain current I_{D} in a saturation region, etc.

In the case of compact modeling using one neural network, there was a disadvantage in that a large amount of training data was required and it took a long time to train. According to the present invention, by using multiple artificial neural networks 200, 300, and 400 instead of one neural network for the compact modeling, less training data is required and the compact model generation time may be reduced.

The first MoE stage 200 generates a first MoE stage output EV1 including first information on a first characteristic (e.g., threshold voltage) of a semiconductor device (e.g., transistor) according to the presence or absence of the short channel effect of the semiconductor device. The first MoE stage 200 includes a first expert network 210, a second expert network 220, and a first gating network 230. Channel width data W, channel length data L, or/and temperature data T of the semiconductor device are input to the first expert network 210, the second expert network 220, and the first gating network 230.

The first expert network 210 receives the channel width data W, the channel length data L, or/and the temperature data T of the semiconductor device and generates a first expert network output e1. The first expert network 210 itself is a neural network. The first expert network 210 includes an input layer, a hidden layer, and an output layer. The number of hidden layers may vary according to embodiments.

When it is assumed that the number of hidden layers is one, the first expert network output e1 is determined depending on the channel width data W, the channel length data L, or/and the temperature data T of the semiconductor device, weights, and an activation function. The channel width data W, the channel length data L, or/and the temperature data T of the semiconductor device are multiplied by the weights. The multiplied values are input to the activation function. The output of the activation function is the first expert network output e1. The activation function may be a sigmoid function or an exponential linear unit (ELU) function.

The first expert network 210 is trained. When the short channel effect occurs in the semiconductor device (e.g., transistor), the first expert network output e1 includes information on a first threshold voltage, information on oxide capacitance per gate area, information on a transistor width, or/and information on total bulk depletion charge, etc. That is, when the short channel effect occurs in the transistor, the first expert network 210 is trained so that the first expert network output e1 includes the information on the first threshold voltage, the information on the oxide capacitance per gate area, the information on the transistor width, or/and the information on the total bulk depletion charge, etc. The first threshold voltage is the threshold voltage of the transistor when the short channel effect occurs in the transistor.

The first expert network output e1 may be expressed in the form of an embedding vector. The embedding vector may include N (N is a natural number) dimensions. Each of the N dimensions includes a real number. For example, in the embedding vector, a first dimension may include 1.5 and a second dimension may include 2.4.

The embedding vector includes the information on the first threshold voltage, the information on the oxide capacitance per gate area, the information on the transistor width, or/and the information on the total bulk depletion charge, etc., but each dimension does not explicitly indicate specific information (e.g., the information on the first threshold voltage).

The second expert network 220 receives the channel width data W, the channel length data L, or/and the temperature data T of the semiconductor device and generates a second expert network output e2. The second expert network 220 itself is a neural network. The second expert network 220 includes the input layer, the hidden layer, and the output layer. The number of hidden layers may vary according to embodiments.

When it is assumed that the number of hidden layers is one, the second expert network output e2 is determined depending on the channel width data W, the channel length data L, or/and the temperature data T of the semiconductor device, the weights, and the activation function. The channel width data W, the channel length data L, or/and the temperature data T of the semiconductor device are multiplied by the weights. The multiplied values are input to the activation function. The output of the activation function is the second expert network output e2. The activation function may be the sigmoid function or the ELU function.

The second expert network 220 is trained. When the semiconductor device (e.g., transistor) has a long channel, the second expert network output e2 includes the information on the second threshold voltage, the information on the oxide capacitance per gate area, the information on the transistor width, or/and the information on the total bulk depletion charge, etc. That is, when the transistor has a long channel, the second expert network 220 is trained so that the second expert network output e2 includes the information on the second threshold voltage, the information on the oxide capacitance per gate area, the information on the transistor width, or/and the information on the total bulk depletion charge. When the transistor has the long channel, the second threshold voltage is the threshold voltage of the transistor.

The second expert network output e2 may be expressed in the form of the embedding vector. The embedding vector may include N (N is a natural number) dimensions. Each of the N dimensions includes a real number.

The embedding vector includes the information on the second threshold voltage, the information on the oxide capacitance per gate area, the information on the transistor width, or/and the information on the total bulk depletion charge, etc., but each dimension does not explicitly indicate specific information (e.g., the information on the second threshold voltage).

The first gating network 230 receives the channel width data W, the channel length data L, or/and the temperature data T of the semiconductor device, and generates a first weight g1 for the first expert network output e1 and a second weight g2 for the second expert network output. The first gating network 230 is a neural network. The first gating network 230 includes the input layer, the hidden layer, and the output layer. The number of hidden layers varies according to embodiments.

The first weight g1 for the first expert network output e1 and the second weight g2 for the second expert network output e2 are determined depending on the channel width data W, the channel length data L, or/and the temperature data of the semiconductor device, the weights, and the activation function. The channel width data W, the channel length data L, or/and the temperature data T of the semiconductor device are multiplied by the weights. The multiplied values are input to the activation function. The output of the activation function is the first weight g1 for the first expert network output e1 and the second weight g2 for the second expert network output e2. The activation function may be the sigmoid function or the ELU function. The sum of the first weight g1 and the second weight g2 may be 1. The first gating network 230 is trained to assign a larger weight g1 or g2 to the more appropriate expert network 210 or 220.

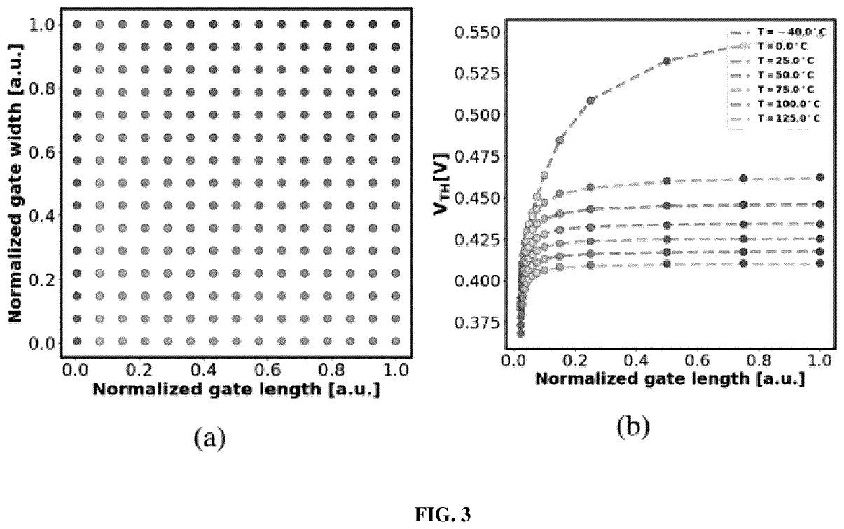

FIGS. 3A and 3B are graphs of a gate width and a threshold voltage according to a gate length of a semiconductor device. FIG. 3A is a graph showing a gate width according to a gate length, and FIG. 3B is a graph showing a threshold voltage according to a gate length. In FIGS. 3A and 3B, the unit [a.u.] is an arbitrary unit.

In FIG. 3A, points with a normalized gate length 0.0 indicate the gate widths when the short channel effect occurs.

Referring to FIG. 3A, when a normalized gate length is 0.0, the first weight g1 may be 0.99 and the second weight g2 may be 0.01. When the short channel effect occurs in the transistor, the first gating network 230 assigns a larger weight to the first expert network output e1. When the normalized gate length is 0.1, the first weight g1 may be 0.6 and the second weight g2 may be 0.4. When the normalized gate length is 1.0, the first weight g1 may be 0.01 and the second weight g2 may be 0.99.

In FIG. 3B, points with a normalized gate length 0.0 indicate the information on the first threshold voltage when the short channel effect occurs in the transistor. In FIG. 3B, the points other than the points with a normalized gate length 0.0 indicate the information on the second threshold voltage when the transistor has the long channel.

Referring to FIG. 3B, when the normalized gate length is 0.0, the first weight g1 may be 0.99 and the second weight g2 may be 0.01. When the normalized gate length is 0.1, the first weight g1 may be 0.6 and the second weight g2 may be 0.4. When the normalized gate length is 1.0, the first weight g1 may be 0.01 and the second weight g2 may be 0.99.

The processor 11 weights the first expert network output e1 by the first weight g1 and the second expert network output e2 by the second weight g2 to generate first weighted expert network outputs g1e1 and g2e2. That is, the presence of the short channel effect in the semiconductor device may be determined based on the first weight g1 and the second weight g2 generated by the first gating network 230. For example, when the first weight g1 is 1 and the second weight g2 is 0, it may be determined that the short channel effect exists in the semiconductor device.

The processor 11 sums the first weighted expert network outputs g1e1 and g2e2 to generate the first MoE stage output EV1. The first MoE stage output EV1 may be expressed in the form of the embedding vector. The summed network outputs are the first MoE stage output EV1. The embedding vector may include N (N is a natural number) dimensions. Each of the N dimensions includes a real number.

The first MoE stage output EV1 includes first information on a first characteristic (e.g., threshold voltage) of the semiconductor device according to the presence or absence of the short channel effect of the semiconductor device. Specifically, when the short channel effect exists in the semiconductor device, the first information may include the information on the threshold voltage, the information on the oxide capacitance per gate area, the information on the transistor width, or/and the information on the total bulk depletion charge, etc. In addition, when the short channel effect does not exist in the semiconductor device, that is, the semiconductor device has the long channel, the first information may include the information on the threshold voltage, the information on the oxide capacitance per gate area, the information on the transistor width, or/and the information on the total bulk depletion charge, etc.

Although the first information is expressed in the form of the embedding vector, each dimension does not explicitly indicate specific information (e.g., the information on the threshold voltage).

The second MoE stage 300 generates a second MoE stage output EV2 including second information on second characteristics (e.g., drain current) of the semiconductor device according to an on state or off state of the semiconductor device (e.g., transistor). According to an embodiment, the second MoE stage output EV2 may further include the first information included in the first MoE stage output EV1. That is, the second MoE stage 300 may generate the second MoE stage output EV2 that includes the first information included in the first MoE stage output EV1 and the second information on the second characteristics (e.g., drain current) of the semiconductor device according to whether the semiconductor device (e.g., transistor) is in the on state or off state.

The on state of the semiconductor device is a state in which a gate-source voltage V_{GS} of the transistor is higher than the threshold voltage of the transistor. The off state of the semiconductor device is a state in which the gate-source voltage V_{GS} of the transistor is lower than the threshold voltage of the transistor. The gate-source voltage V_{GS} can be expressed gate-source voltage data V_{GS}.

The second MoE stage 300 includes a third expert network 310, a fourth expert network 320, and a second gating network 330. The first MoE stage output EV1 and the gate-source voltage data V_{GS} of the semiconductor device (e.g., transistor) are input to the second MoE stage 300. According to an embodiment, the first MoE stage output EV1, the gate-source voltage data V_{GS} of the semiconductor device (e.g., transistor), and a body source voltage data V_{BS} of the semiconductor device are input to the second MoE stage 300.

The third expert network 310 receives the first MoE stage output EV1 and the gate-source voltage data V_{GS} of the semiconductor device (e.g., transistor) to generate a third expert network output e3. According to an embodiment, the third expert network 310 may receive the first MoE stage output EV1, the gate-source voltage data V_{GS} of the semiconductor device (e.g., transistor), and the body-source voltage data V_{BS} of the semiconductor device to generate the third expert network output e3. The first MoE stage output EV1 and gate-source voltage data V_{GS} of the semiconductor device (e.g., transistor) may be expressed as one embedding vector. Also, according to an embodiment, the first MoE stage output EV1, the gate-source voltage data V_{GS} of the semiconductor device, and the body-source voltage data V_{BS} of the semiconductor device may be expressed as one embedding vector.

The third expert network 310 itself is a neural network. The third expert network 310 includes the input layer, the hidden layer, and the output layer. The number of hidden layers may vary according to embodiments.

When it is assumed that the number of hidden layers is one, the third expert network output e3 is determined depending on the first MoE stage output EV1, the gate-source voltage data V_{GS} of the semiconductor device (e.g., transistor), the weights, and the activation function. According to an embodiment, the third expert network output e3 may be determined depending on the first MoE stage output EV1, the gate-source voltage data V_{GS} of the semiconductor device (e.g., transistor), the body-source voltage data V_{BS} of the semiconductor device, the weights, and the activation function. The first MoE stage output EV1 and the gate-source voltage data V_{GS} of the semiconductor device are multiplied by the weights. According to an embodiment, the first MoE stage output EV1, the gate-source voltage data V_{GS} of the semiconductor device, and the body-source voltage data V_{BS} of the semiconductor device are multiplied by the weights. The multiplied values are input to the activation function. The output of the activation function is the third expert network output e3. The activation function may be the sigmoid function or the ELU function.

The third expert network 310 is trained. The third expert network output e3 includes information on the drain current I_{D} when the semiconductor device is in the on state. According to an embodiment, the third expert network output e3 includes the first information and the information on the drain current I_{D} when the semiconductor device is in the on state.

When the semiconductor device is in the on state, the third expert network 310 is trained so that the drain current I_{D} has an approximately linear or quadratic function property with respect to the gate-source voltage V_{GS}. Having the approximately linear or quadratic function property means having an approximate relationship similar to the linear or quadratic function, rather than the exact linear or quadratic function.

The third expert network output e3 may be expressed in the form of the embedding vector. The embedding vector may include N (N is a natural number) dimensions. Each of the N dimensions includes a real number.

The fourth expert network 320 receives the first MoE stage output EV1 and the gate-source voltage data V_{GS} of the semiconductor device (e.g., transistor) to generate a fourth expert network output e4. According to an embodiment, the fourth expert network 320 may receive the first MoE stage output EV1, the gate-source voltage data V_{GS} of the semiconductor device (e.g., transistor), and the body-source voltage data V_{BS} of the semiconductor device to generate the fourth expert network output e4. The first MoE stage output EV1 and gate-source voltage data V_{GS} of the semiconductor device (e.g., transistor) may be expressed as one embedding vector. Also, according to an embodiment, the first MoE stage output EV1, the gate-source voltage data V_{GS} of the semiconductor device, and the body-source voltage data V_{BS} of the semiconductor device may be expressed as one embedding vector.

The fourth expert network 320 itself is a neural network. The fourth expert network 320 includes the input layer, the hidden layer, and the output layer. The number of hidden layers may vary according to embodiments.

When it is assumed that the number of hidden layers is one, the fourth expert network output e4 is determined depending on the first MoE stage output EV1, the gate-source voltage data V_{GS} of the semiconductor device (e.g., transistor), the weights, and the activation function. According to an embodiment, the fourth expert network output e4 may be determined depending on the first MoE stage output EV1, the gate-source voltage data V_{GS} of the semiconductor device (e.g., transistor), the body-source voltage data V_{BS} of the semiconductor device, the weights, and the activation function. The first MoE stage output EV1 and the gate-source voltage data V_{GS} of the semiconductor device are multiplied by the weights. According to an embodiment, the first MoE stage output EV1, the gate-source voltage data V_{GS} of the semiconductor device (e.g., transistor), and the body-source voltage data V_{BS} of the semiconductor device are multiplied by the weights. The multiplied values are input to the activation function. The output of the activation function is the fourth expert network output e4. The activation function may be the sigmoid function or the ELU function.

The fourth expert network 320 is trained. The fourth expert network output e4 includes the information on the drain current I_{D} when the semiconductor device is in the off state. According to an embodiment, the fourth expert network output e4 includes the first information and the information on the drain current I_{D} when the semiconductor device is in the off state. When the semiconductor device is in the off state, the fourth expert network 320 is trained so that the drain current I_{D} has an approximately exponential function property with respect to the gate-source voltage V G s. Having the approximately exponential property means having an approximate relationship similar to an exponential function rather than an exact exponential function.

The fourth expert network output e4 may be expressed in the form of the embedding vector. The embedding vector may include N (N is a natural number) dimensions. Each of the N dimensions includes a real number.

The second gating network 330 is a neural network. The second gating network 330 includes the input layer, the hidden layer, and the output layer. The number of hidden layers may vary according to embodiments.

A third weight g3 for the third expert network output e3 and a fourth weight g4 for the fourth expert network output e4 are determined depending on the first information on the characteristics of the semiconductor device depending on the presence or absence of the short channel effect of the semiconductor device, the first MoE stage output EV1, the gate-source voltage data V_{GS} of the semiconductor device (e.g., transistor), the function of the weights, and the activation function. According to an embodiment, the third weight g3 for the third expert network output e3 and the fourth weight g4 for the fourth expert network output e4 may be determined depending on the first information, the first MoE stage output EV1, the gate-source voltage data V_{GS} of the semiconductor device (e.g., transistor), the body-source voltage data V_{BS} of the semiconductor device, the weights, and the activation function. The first MoE stage output EV1 and the gate-source voltage data V_{GS} of the semiconductor device are multiplied by the weights. According to an embodiment, the first MoE stage output EV1, the gate-source voltage data V_{GS} of the semiconductor device, and the body-source voltage data V_{BS} of the semiconductor device are multiplied by the weights. The multiplied values are input to the activation function. The output of the activation function is the third weight g3 for the third expert network output e3 and the fourth weight g4 for the fourth expert network output e4. The activation function may be the ELU function. The sum of the third weight g3 and the fourth weight g4 may be 1. The second gating network 330 is trained to assign a larger weight g3 or g4 to the more appropriate expert network 310 or 320.

The processor 11 weights the third expert network output e3 by the third weight g3 and the fourth expert network output e4 by the fourth weight g4 to generate second weighted expert network outputs g3e3 and g4e4. That is, it may be determined whether the semiconductor device is classified as being in the on state or off state according to the third weight g3 and the fourth weight g4 generated by the second gating network 330. For example, when the first weight g1 is 1 and the second weight g2 is 0, the semiconductor device may be classified as being in the on state.

The processor 11 sums the second weighted expert network outputs g3e3 and g4e4 to generate the second MoE stage output EV2. The second MoE stage output EV2 may be expressed in the form of the embedding vector. The summed network outputs are the second MoE stage output EV2. The second MoE stage output EV2 includes the second information on the characteristics (e.g., drain current) of the semiconductor device according to the on state or off state of the semiconductor device. According to an embodiment, the second MoE stage output EV2 may include both the first information and the second information.

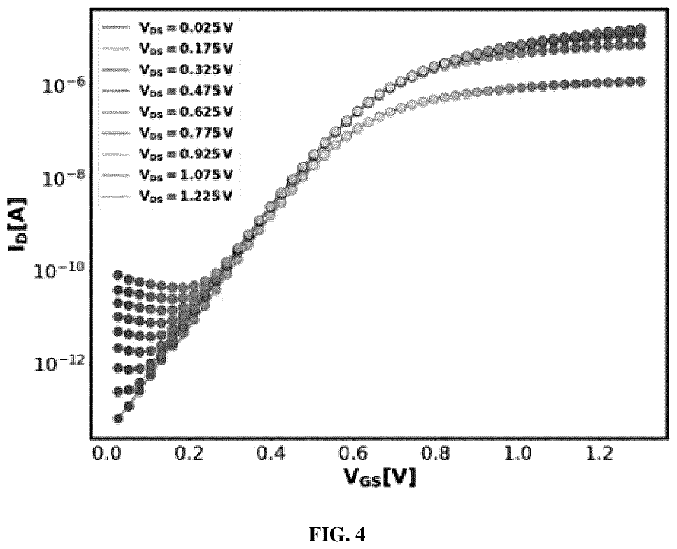

FIG. 4 is a graph of the drain current according to the gate-source voltage.

Referring to FIGS. 2 and 4, points with the gate-source voltage V_{GS} greater than 0.6 indicate the information on the drain current I_{D} when the semiconductor device is in the on state. That is, it is the drain current I_{D} modeled by the third expert network 310. The points other than the points with the gate-source voltage V_{GS} greater than 0.6 indicate the information on the drain current I_{D} when the semiconductor device is in the off state. That is, it is the drain current I_{D} modeled by the fourth expert network 320.

The second gating network 330 receives the first MoE stage output EV1 and the gate-source voltage data V_{GS} of the semiconductor device (e.g., transistor) to generate the third weight g3 for the third expert network output e3 and the fourth expert value g4 for the fourth expert network output e4. According to an embodiment, the second gating network 330 may receive the first MoE stage output EV1, the gate-source voltage data V_{GS} of the semiconductor device (e.g., transistor), and the body-source voltage data V_{BS} of the semiconductor device to generate the third weight g3 for the third expert network output e3 and the fourth weight g4 for the fourth expert network output e4.

The third MoE stage 400 estimates the current I_{D} of the semiconductor device according to the cutoff region, the linear region, or the saturation region of the semiconductor device. That is, the drain current I_{D} is estimated.

The cutoff region of the semiconductor device is a region where the gate-source voltage V_{GS} of the semiconductor device is smaller than the threshold voltage. The linear region of the semiconductor device is a region where a difference between the gate-source voltage V_{GS} of the semiconductor device and the threshold voltage is larger than the drain-source voltage V_{DS} of the semiconductor device. The saturation region of the semiconductor device is a region where the difference between the gate-source voltage V_{GS} of the semiconductor device and the threshold voltage is smaller than the drain-source voltage V_{DS} of the semiconductor device.

The third MoE stage 400 includes a fifth expert network 410, a sixth expert network 420, and a third gating network 430. The second MoE stage output EV2 and the drain-source voltage data V_{DS} of the semiconductor device (e.g., transistor) are input to the third MoE stage 400.

The fifth expert network 410 receives the second MoE stage output EV2 and the drain-source voltage data V_{DS} of the semiconductor device to generate a fifth expert network output e5. The second MoE stage output EV2 and the drain-source voltage data V_{DS} of the semiconductor device (e.g., transistor) may be expressed as one embedding vector.

The fifth expert network 410 itself is a neural network. The fifth expert network 410 includes the input layer, the hidden layer, and the output layer. The number of hidden layers may vary according to embodiments.

When it is assumed that the number of hidden layers is one, the fifth expert network output e5 is determined depending on the second MoE stage output EV2, the drain-source voltage data V_{DS} of the semiconductor device, the weights, and the activation function. The second MoE stage output EV2 and the drain-source voltage data V_{DS} of the semiconductor device are multiplied by the weights. The multiplied values are input to the activation function. The output of the activation function is the fifth expert network output e5. The activation function may be the sigmoid function or the ELU function.

The fifth expert network 410 is trained. The fifth expert network output e5 includes the information on the drain current I_{D} when the semiconductor device is in the cutoff region. According to an embodiment, the fifth expert network output e5 may include the first information, the second information, and the information on the drain current I_{D} when the semiconductor device is in the cutoff region. The fifth expert network 410 is trained so that the drain current I_{D} does not greatly depend on the drain-source voltage data V_{DS}.

The fifth expert network output e5 may be expressed in the form of the embedding vector. The embedding vector may include N (N is a natural number) dimensions. Each of the N dimensions includes a real number.

The sixth expert network 420 receives the second MoE stage output EV2 and the drain-source voltage data V_{DS} of the semiconductor device to generate a sixth expert network output e6. The second MoE stage output EV2 and the drain-source voltage data V_{DS} of the semiconductor device (e.g., transistor) may be expressed as one embedding vector.

The sixth expert network 420 itself is a neural network. The sixth expert network 420 includes the input layer, the hidden layer, and the output layer. The number of hidden layers may vary according to embodiments.

When it is assumed that the number of hidden layers is one, the sixth expert network output e6 is determined depending on the second MoE stage output EV2, the drain-source voltage data V_{DS} of the semiconductor device, the weights, and the activation function. The second MoE stage output EV2 and the drain-source voltage data V_{DS} of the semiconductor device are multiplied by the weights. The multiplied values are input to the activation function. The output of the activation function is the sixth expert network output e6. The activation function may be the sigmoid function or the ELU function.

The sixth expert network 420 is trained. The sixth expert network output e6 includes the information on the drain current I_{D} when the semiconductor device is in the linear region. According to an embodiment, the sixth expert network output e6 may include the first information, the second information, and the information on the drain current I_{D} when the semiconductor device is in the linear region. The sixth expert network 420 is trained so that the drain current I_{D} has an approximately linear function property with respect to the drain-source voltage data V_{DS}. Having the approximately function property means having an approximate relationship similar to a linear function rather than the exact linear function.

The sixth expert network output e6 may be expressed in the form of the embedding vector. The embedding vector may include N (N is a natural number) dimensions. Each of the N dimensions includes a real number.

The sixth expert network 420 receives the second MoE stage output EV2 and the drain-source voltage data V_{DS} of the semiconductor device to generate the sixth expert network output e6. The second MoE stage output EV2 and the drain-source voltage data V_{DS} of the semiconductor device (e.g., transistor) may be expressed as one embedding vector.

When the semiconductor device is in the saturation region, the fifth expert network output e5 and the sixth expert network output e6 may include the information on the drain current I_{D}.

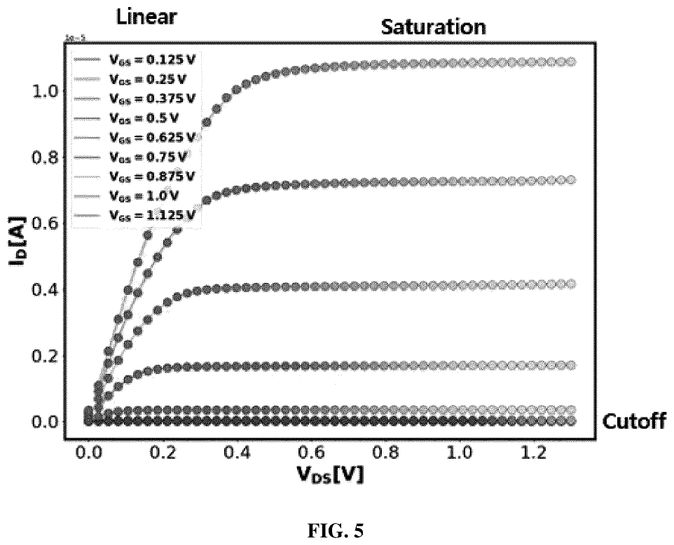

FIG. 5 is a graph of the drain current depending on the drain-source voltage.

Referring to FIGS. 2 and 5, points where the drain current I_{D} is greater than zero indicate the information on the drain current I_{D} when the semiconductor device is in the on state. That is, it is the drain current I_{D} modeled by the third expert network 310. The points other than the points where the drain current I_{D} is greater than zero indicate the information on the drain current I_{D} when the semiconductor device is in the off state. That is, it is the drain current I_{D} modeled by the fourth expert network 320.

The third gating network 430 receives the second MoE stage output EV2 and the drain-source voltage data V_{DS} of the semiconductor device, and calculates the fifth weight g5 for the fifth expert network output e5 and the sixth weight g6 for the sixth network output e6.

The third gating network 430 is a neural network. The third gating network 430 includes the input layer, the hidden layer, and the output layer. The fifth weight g5 for the fifth expert network output e5 and the sixth weight g6 for the sixth expert network output e6 are determined depending on the second MoE stage output EV2, the drain-source voltage data V_{DS} of the semiconductor device, the weights, and the activation function. The second MoE stage output EV2 and the drain-source voltage data V_{DS} of the semiconductor device are multiplied by the weights. The multiplied values are input to the activation function. The output of the activation function is the fifth weight g5 for the fifth expert network output e5 and the sixth weight g6 for the sixth expert network output e6. The activation function may be the sigmoid function or the ELU function. The sum of the fifth weight g5 and the sixth weight g6 may be 1. The third gating network 430 is trained to assign a larger weight g5 or g6 to the more appropriate expert network 410 or 420.

The processor 11 weights the fifth expert network output e5 by the fifth weight g5 and the sixth expert network output e6 by the sixth weight g6 to generate third weighted expert network outputs g5e5 and g6e6. That is, it may be determined whether the semiconductor device is classified as being in the cutoff region, the linear region, or the saturation region according to the fifth weight g5 and the sixth weight g6 generated by the third gating network 430. When the fifth weight g5 is 0.99 and the sixth weight g6 is 0.01, the semiconductor device may be classified as being in the linear region. When the fifth weight g5 is 0.11 and the sixth weight g6 is 0.99, the semiconductor device may be classified as being in the cutoff region. When the fifth weight g5 is 0.5 and the sixth weight g6 is 0.5, the semiconductor device may be classified as being in the saturation region. Accordingly, when the fifth weight g5 is 0.5 and the sixth weight g6 is 0.5, the current I_{D} according to the saturation region is output from the third MoE stage 400. When the semiconductor device is in the saturation region, the information on the drain current I_{D} may be estimated depending on the fifth expert network output e5 and the sixth expert network output e6.

The processor 11 sums the third weighted expert network outputs g5e5 and g6e6 to estimate the current I_{D}. The summed network outputs are the current I_{D}.

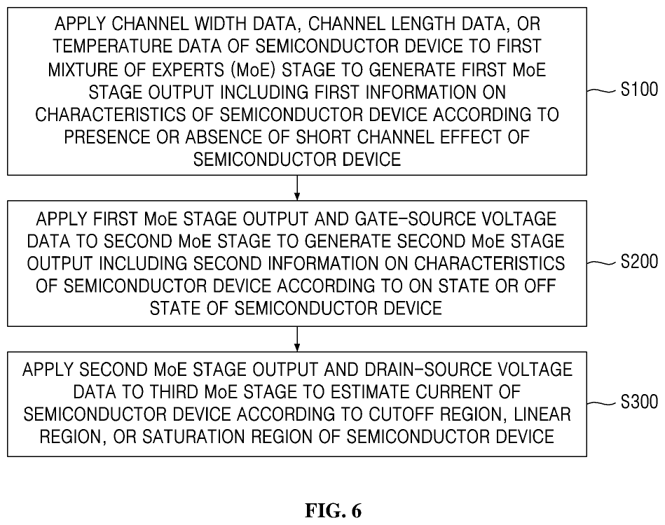

FIG. 6 is a flowchart for describing the method of semiconductor device compact modeling using multiple specialized artificial neural networks for each semiconductor device operation region according to the embodiment of the present invention.

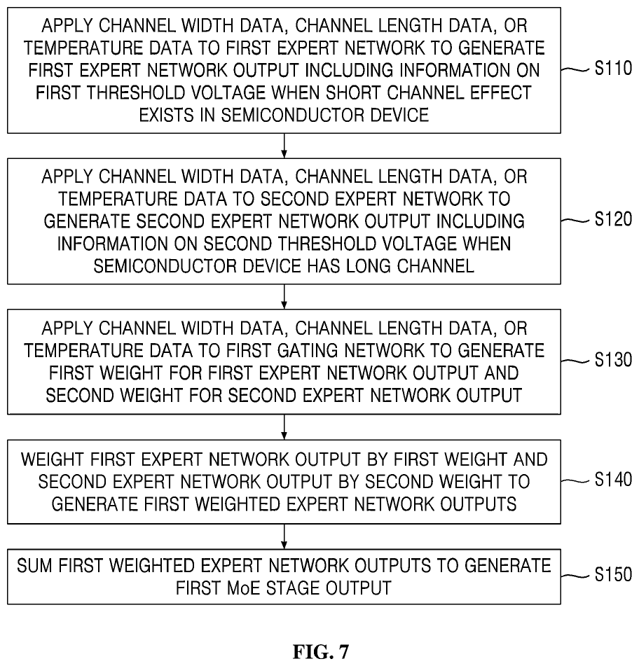

Referring to FIGS. 1 to 6, the processor 11 applies the channel width data W, the channel length data L, or the temperature data T of the semiconductor device to the first MoE stage 200 to generate the first MoE stage output EV1 including the first information on the characteristics of the semiconductor device according to the presence or absence of the short channel effect of the semiconductor device (S100). An operation of generating the first MoE stage output EV1 is described in detail with reference to FIG. 7.

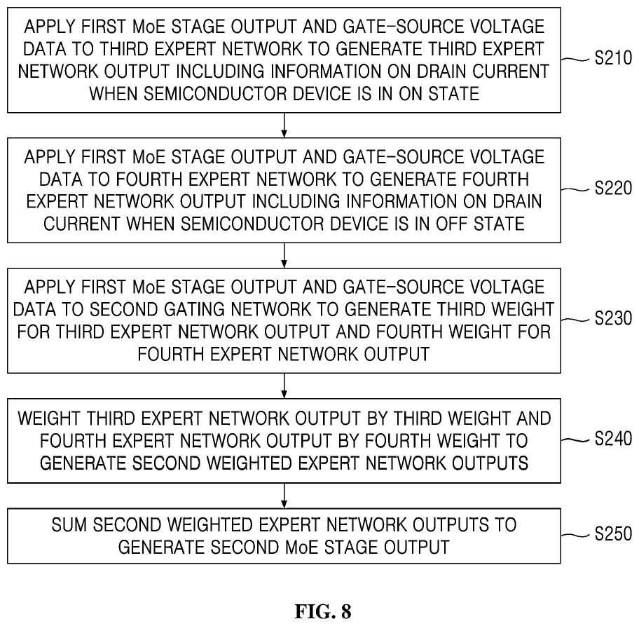

The processor 11 applies the first MoE stage output EV1 and the gate-source voltage data V_{GS} to the second MoE stage 300 to generate the second MoE stage output EV2 including the second information on the characteristics of the semiconductor device according to the on state or off state of the semiconductor device (S200). An operation of generating the second MoE stage output EV2 is described in detail with reference to FIG. 8.

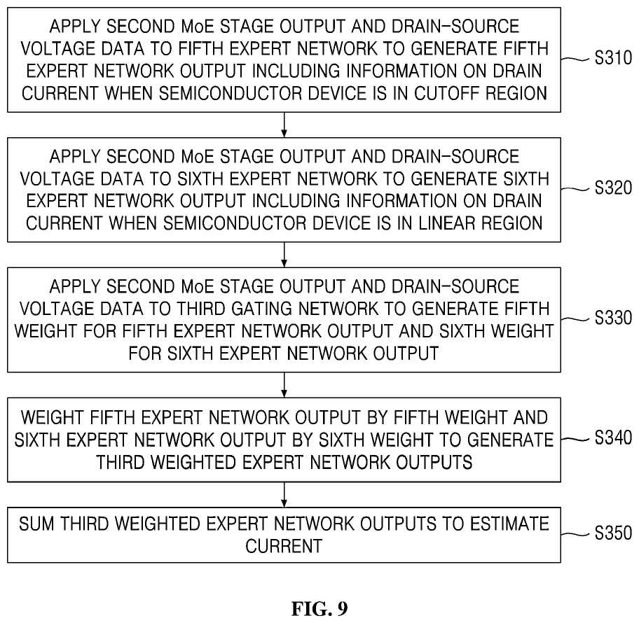

The processor 11 applies the second MoE stage output EV2 and the drain-source voltage data V_{DS} to the third MoE stage 400 to estimate the current I_{D} of the semiconductor device according to the cutoff region, the linear region, or the saturation region of the semiconductor device (S300). The estimation of the current I_{D} is described in detail in FIG. 9.

FIG. 7 is a flowchart for describing an operation of generating the first MoE stage output of FIG. 6.

Referring to FIGS. 1 to 7, the processor 11 applies the channel width data W, the channel length data L, or the temperature data T to the first expert network 210 to generate the first expert network output e1 including the information on the first threshold voltage when the short channel effect exists in the semiconductor device (S110).

The processor 11 applies the channel width data W, the channel length data L, or the temperature data T to the second expert network 220 to generate the second expert network output e2 including the information on the second threshold voltage when the semiconductor device has the long channel (S120).

The processor 11 applies the channel width data W, the channel length data L, or the temperature data T to the first gating network 230 to generate the first weight g1 for the first expert network output e1 and the second weight g2 for the second expert network output e2 (S130).

The processor 11 weights the first expert network output e1 by the first weight g1 and the second expert network output e2 by the second weight g2 to generate the first weighted expert network outputs g1e1 and g2e2 (S140).

The processor 11 sums the first weighted expert network outputs g1e1 and g2e2 to generate the first MoE stage output EV1 (S150).

FIG. 8 is a flowchart for describing an operation of generating the second MoE stage output of FIG. 6.

Referring to FIGS. 1 to 6 and 8, the processor 11 applies the first MoE stage output EV1 and the gate-source voltage data V_{GS} to the third expert network 310 to generate the third expert network output e3 including the information on the drain current I_{D} when the semiconductor device is in the on state (S210).

The processor 11 applies the first MoE stage output EV1 and the gate-source voltage data V_{GS} to the fourth expert network 320 to generate the fourth expert network output e4 including the information on the drain current I_{D} when the semiconductor device is in the off state (S220).

The processor 11 applies the first MoE stage output and the gate-source voltage data to the second gating network to generate the third weight for the third expert network output and the fourth weight for the fourth expert network output (S230).

The processor 11 weights the third expert network output by the third weight and the fourth expert network output by the fourth weight to generate the second weighted expert network outputs (S240).

The processor 11 sums the second weighted expert network outputs to generate the second MoE stage output (S250).

FIG. 9 is a flowchart for describing an operation of generating the third MoE stage output of FIG. 6.

Referring to FIGS. 1 to 6 and 9, the processor 11 applies the second MoE stage output EV2 and the drain-source voltage data V_{DS} to the fifth expert network 410 to generate the fifth expert network output e5 when the semiconductor device is in the cutoff region (S310).

The processor 11 applies the second MoE stage output EV2 and the drain-source voltage data V_{DS} to the sixth expert network 420 to generate the sixth expert network output e6 when the semiconductor device is in the linear region (S320).

The processor 11 applies the second MoE stage output EV2 and the drain-source voltage data V_{DS} to the third gating network 430 to generate the fifth weight g5 for the fifth expert network output e5 and the sixth weight g6 for the sixth network output e6 (S330).

The processor 11 weights the fifth expert network output e5 by the fifth weight g5 and the sixth expert network output e6 by the sixth weight g6 to generate the third weighted expert network outputs g5e5 and g6e6 (S340).

The processor 11 sums the third weighted expert network outputs to estimate the current I_{D} (S350).

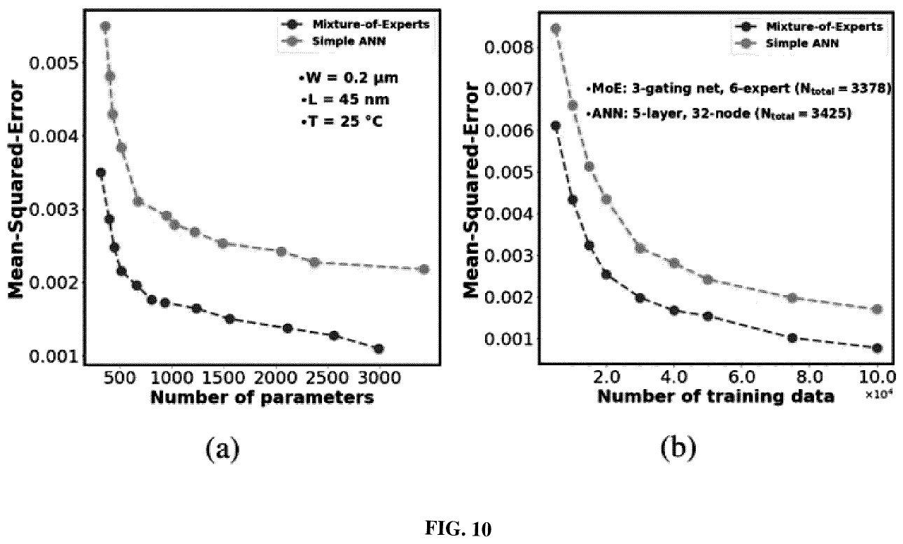

FIGS. 10A and 10B are graphs of a conventional compact modeling method using one neural network and the method of semiconductor device compact modeling using multiple specialized artificial neural networks for each semiconductor device operation region of the present invention.

FIG. 10A is a graph showing a mean square error according to the number of parameters of the neural network. FIG. 10B is a graph showing the mean square error according to the number of pieces of training data of the neural network. In FIGS. 10A and 10B, orange indicates a method of compact modeling according to a general neural network, and graph with lower means-squared error indicates the method of semiconductor device compact modeling using multiple specialized artificial neural networks for each semiconductor device according to the present invention.

Referring to FIGS. 10A and 10B, it can be seen that the method of semiconductor device compact modeling using multiple specialized artificial neural networks for each semiconductor device operation region according to the present invention has a mean square error smaller than that of the conventional method of semiconductor device compact modeling according to a neural network.

According to the method and system for semiconductor device compact modeling using multiple specialized artificial neural networks for each semiconductor device operation region according to an embodiment of the present invention, it is possible to reduce a compact model generation time by using a mixture of experts (MoE) approach method for compact modeling.

Although the present invention has been described with reference to exemplary embodiments shown in the accompanying drawings, they are only examples. It will be understood by those skilled in the art that various modifications and other equivalent exemplary embodiments are possible for the present invention. Accordingly, an actual technical protection scope of the present invention is to be defined by the following claims.

What is claimed is:

1. A method of semiconductor device compact modeling using multiple specialized artificial neural networks for each semiconductor device operation region, the method comprising:
applying channel width data, channel length data, or temperature data of the semiconductor device to a first mixture of experts (MoE) stage to generate a first MoE stage output including first information on characteristics of the semiconductor device according to presence or absence of a short channel effect of the semiconductor device;
applying the first MoE stage output and gate-source voltage data to a second MoE stage to generate a second MoE stage output including second information on the characteristics of the semiconductor device according to an on state or off state of the semiconductor device; and
applying the second MoE stage output and drain-source voltage data to a third MoE stage to estimate a current of the semiconductor device according to a cutoff region, a linear region, or a saturation region of the semiconductor device.

2. The method of claim 1, wherein the generating of the first MoE stage output includes:
applying the channel width data, the channel length data, or the temperature data to a first expert network to generate a first expert network output including information on a first threshold voltage when the short channel effect exists in the semiconductor device;
applying the channel width data, the channel length data, or the temperature data to a second expert network to generate a second expert network output including information on a second threshold voltage when the semiconductor device has a long channel;
applying the channel width data, the channel length data, or the temperature data to a first gating network to generate a first weight for the first expert network output and a second weight for the second expert network output;
weighting the first expert network output by the first weight and the second expert network output by the second weight to generate first weighted expert network outputs; and
summing the first weighted expert network outputs to generate the first MoE stage output.

3. The method of claim 1, wherein the generating of the second MoE stage output includes:
applying the first MoE stage output and the gate-source voltage data to a third expert network to generate a third expert network output including information on a drain current when the semiconductor device is in the on state;
applying the first MoE stage output and the gate-source voltage data to a fourth expert network to generate a fourth expert network output including the information on the drain current when the semiconductor device is in the off state;
applying the first MoE stage output and the gate-source voltage data to a second gating network to generate a third weight for the third expert network output and a fourth weight for the fourth expert network output;
weighting the third expert network output by the third weight and the fourth expert network output by the fourth weight to generate second weighted expert network outputs; and
summing the second weighted expert network outputs to generate the second MoE stage output.

4. The method of claim 1, wherein the generating of the third MoE stage output includes:
applying the second MoE stage output and the drain-source voltage data to a fifth expert network to generate a fifth expert network output including information on a drain current when the semiconductor device is in the cutoff region;
applying the second MoE stage output and the drain-source voltage data to a sixth expert network to generate a sixth expert network output including the information on the drain current when the semiconductor device is in the linear region;
applying the second MoE stage output and the drain-source voltage data to a third gating network to generate a fifth weight for the fifth expert network output and a sixth weight for the sixth expert network output;
weighting the fifth expert network output by the fifth weight and the sixth expert network output by the sixth weight to generate third weighted expert network outputs; and
summing the third weighted expert network outputs to estimate the current.

5. A system for semiconductor device compact modeling using multiple specialized artificial neural networks for each semiconductor device operation region, the system comprising:
a memory that stores instructions; and
a processor that executes the instructions,
wherein the instructions are implemented to apply channel width data, channel length data, or temperature data of the semiconductor device to the first MoE stage to generate a first MoE stage output including first information on characteristics of the semiconductor device according to presence or absence of a short channel effect of the semiconductor device;
apply the first MoE stage output and gate-source voltage data to a second MoE stage to generate a second MoE stage output including second information on the characteristics of the semiconductor device according to the on state or off state of the semiconductor device; and
apply the second MoE stage output and drain-source voltage data to a third MoE stage to estimate a current of the semiconductor device according to a cutoff region, a linear region, or a saturation region of the semiconductor device.

6. The system of claim 5, wherein the instructions to generate the first MoE stage output are implemented to apply the channel width data, the channel length data, or the temperature data to a first expert network to generate a first expert network output including information on a first threshold voltage when the short channel effect exists in the semiconductor device,
apply the channel width data, the channel length data, or the temperature data to a second expert network to generate a second expert network output including information on a second threshold voltage when the semiconductor device has a long channel,
apply the channel width data, the channel length data, or the temperature data to a first gating network to generate a first weight for the first expert network output and a second weight for the second expert network output,
weight the first expert network output by the first weight and the second expert network output by the second weight to generate first weighted expert network outputs, and
sum the first weighted expert network outputs to generate the first MoE stage output.

7. The system of claim 5, wherein the instructions to generate the second MoE stage output are implemented to apply the first MoE stage output and the gate-source voltage data to a third expert network to generate a third expert network output including information on a drain current when the semiconductor device is in the on state,
apply the first MoE stage output and the gate-source voltage data to a fourth expert network to generate a fourth expert network output including the information on the drain current when the semiconductor device is in the off state,
apply the first MoE stage output and the gate-source voltage data to a second gating network to generate a third weight for the third expert network output and a fourth weight for the fourth expert network output,
weight the third expert network output by the third weight and the fourth expert network output by the fourth weight to generate second weighted expert network outputs, and
sum the second weighted expert network outputs to generate the second MoE stage output.

8. The system of claim 5, wherein the instructions to generate the third MoE stage output are implemented to apply the second MoE stage output and the drain-source voltage data to a fifth expert network to generate a fifth expert network output including information on a drain current when the semiconductor device is in the cutoff region,
apply the second MoE stage output and the drain-source voltage data to a sixth expert network to generate a sixth expert network output including the information on the drain current when the semiconductor device is in the linear region,
apply the second MoE stage output and the drain-source voltage data to a third gating network to generate a fifth weight for the fifth expert network output and a sixth weight for the sixth expert network output, and
weight the fifth expert network output by the fifth weight and the sixth expert network output by the sixth weight to generate third weighted expert network outputs, and
sum the third weighted expert network outputs to estimate the current.
